(19) United States
(12) Patent Application Publication
(10) Pub. No.: US 2019/0195230 A1
(43) Pub. Date: Jun. 27, 2019

(54) CENTRIFUGAL FAN

(71) Applicant: Nidec Corporation, Kyoto (JP)

(72) Inventors: Kazuhiro INOUCHI, Kyoto (JP); Junya MATSUYAMA, Kyoto (JP)

(21) Appl. No.: 16/190,449

(22) Filed: Nov. 14, 2018

(30) Foreign Application Priority Data
Dec. 22, 2017 (JP) 2017-246706

(51) Int. Cl. F04D 17/02; F04D 17/16; F04D 25/08; F04D 29/22; F04D 29/58; H02K 7/14; H02K 1/27

(52) U.S. Cl. CPC F04D 17/025; F04D 17/16; F04D 25/082; H02K 1/27; F04D 29/5806; H02K 7/14; F04D 29/2261

(57) ABSTRACT

A centrifugal fan that sends out in a radial direction a fluid sucked from an axial direction, includes an impeller rotatable about a center axis extending in a top-bottom direction, and a motor that rotates the impeller. The motor includes a rotor rotatable about the center axis, and a stator that faces at least a portion of the rotor in the radial direction. The impeller includes an impeller hub fixed to the rotor, centrifugal vanes disposed in a circumferential direction on a radial-direction outer side of the impeller hub, and axial flow vanes disposed in the circumferential direction on a radial-direction inner side of the impeller hub. The axial flow vanes are disposed on an axial-direction upper side of the stator.

### CROSS REFERENCE TO RELATED APPLICATIONS

This application claims the benefit of priority to Japanese Patent Application No. 2017-246706 filed on Dec. 22, 2017. The entire contents of this application are hereby incorporated herein by reference.

### BACKGROUND OF THE INVENTION

### 1. Field of the Invention

The present disclosure relates to a centrifugal fan.

### 2. Description of the Related Art

To date, a blowing device having a plurality of vanes is known. The existing blowing device relates to an electric blowing device including an impeller that has a plurality of vanes. A current of air sucked from a suction port by rotation of the vanes passes through the inside of the impeller, a diffuser, and a bracket, and, while cooling a stator, a rotor and the like, finally is exhausted to the outside of the electric blowing device. In addition, in this electric blowing device, by increasing the surface area of the stator core, the area of contact with the current of air is increased and cooling efficiency is improved.

However, in the existing electric blowing device, the surface area of the stator core is increased by stacking plural types of electromagnetic steel plates having different shapes. Therefore, there is a possibility that the manufacturing cost may become relatively high.

### SUMMARY OF THE INVENTION

A centrifugal fan according to an exemplary embodiment of the present disclosure is a centrifugal fan that sends out in a radial direction a fluid sucked from an axial direction, and includes an impeller rotatable about a center axis extending in a top-bottom direction, and a motor that rotates the impeller. The motor includes a rotor rotatable about the center axis, and a stator that faces at least a portion of the rotor in the radial direction. The impeller includes an impeller hub fixed to the rotor, a plurality of centrifugal vanes disposed in a circumferential direction on a radial-direction outer side of the impeller hub, and a plurality of axial flow vanes disposed in the circumferential direction on a radial-direction inner side of the impeller hub. The axial flow vanes are disposed on an axial-direction upper side of the stator.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a centrifugal fan as viewed from an axial-direction upper side.

FIG. 2 is a perspective view of the centrifugal fan as viewed from an axial-direction lower side.

FIG. 3 is a sectional view illustrating the centrifugal fan of a configuration example as viewed from a radial direction.

FIG. 4 is a sectional view illustrating the centrifugal fan of another configuration example as viewed from the radial direction.

### DETAILED DESCRIPTION OF THE PREFERRED EMBODIMENTS

Exemplary embodiments of the present disclosure will be described below with reference to the drawings. Further, in this specification, in a centrifugal fan 100, a rotation axis of a motor 2 will be referred to as “center axis CA”, and a direction parallel to the center axis CA will be referred to as “axial direction”. As an axial side, the direction from a lower housing 32 (to be described later) toward an upper housing 31 (to be described later) along the axial direction will be referred to as “axial-direction upper side”. As another axial side, the direction from the upper housing 31 to the lower housing 32 along the axial direction will be referred to as “axial-direction lower side”. For each component, an end portion on the axial-direction upper side will be referred to as “upper end portion” and an end position on the axial-direction upper side will be referred to as “upper end”. For each component, an end portion on the axial-direction lower side will be referred to as “lower end portion” and an end position on the axial-direction lower side will be referred to as “lower end”. In addition, for the surfaces of each component element, a surface facing toward the axial-direction upper side will be referred to as “upper surface” and a surface facing toward the axial-direction lower side will be referred to as “lower surface”.

The direction perpendicular to the center axis CA will be referred to as “radial direction”, and the rotational direction of a rotor 21 about the center axis CA will be referred to as “circumferential direction”. The direction toward the center axis CA along the radial direction will be referred to as “radial-direction inner side” and the direction away from the center axis CA along the radial direction will be referred to as “radial-direction outer side”. For each component, an end portion on the radial-direction inner side will be referred to as a “radial-direction inner end portion” and an end position on the radial-direction inner side will be referred to as a “radial-direction inner end”. For each component, an end portion on the radial-direction outer side will be referred to as “radial-direction outer end portion” and an end position on the radial-direction outer side will be referred to as “radial-direction outer end”. In addition, for the side surfaces of each component, the side surface facing toward the radial-direction inner side will be referred to as “radial-direction inner side surface” and the side surface facing toward the radial-direction outer side will be referred to as “radial-direction outer side surface”.

Further, note that designations such as those of the directions, planes, and constituent parts described above do not indicate positional relationships, directions, and the like in the case of being incorporated in an actual device.

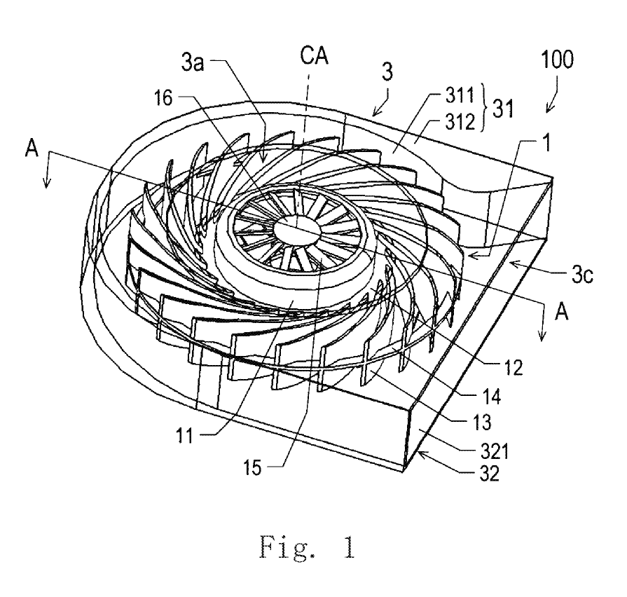

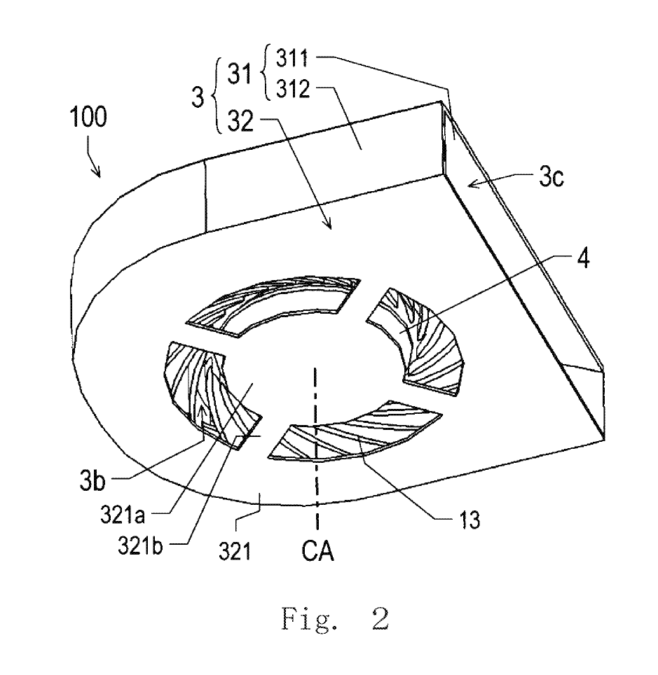

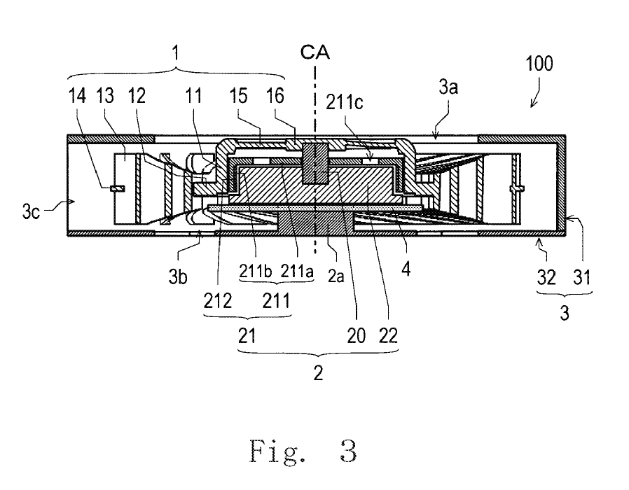

FIG. 1 is a perspective view of a centrifugal fan as viewed from the axial-direction upper side. FIG. 2 is a perspective view of the centrifugal fan as viewed from the axial-direction lower side. FIG. 3 is a sectional view illustrating the centrifugal fan of a configuration example as viewed from the radial direction. Further, in FIG. 1, in order to make the configuration easier to understand, a housing 3 is illustrated in a transparent manner. In addition, FIG. 3 is a cross section of the centrifugal fan 100 taken along a plane including the center axis CA along a one-dot chain line A-A in FIG. 1.

The centrifugal fan 100 is a blowing device that sends out in a radial direction a fluid that is sucked from the axial direction. Further, in the present embodiment, the fluid that the centrifugal fan 100 sucks and sends out is air. The centrifugal fan 100 is used for, for example, a cooling fan of an electronic device that is required to be reduced in thickness. However, the application of the centrifugal fan 100 is not limited to this example. The centrifugal fan 100 includes an impeller 1 and the motor 2. In the present embodiment, the centrifugal fan 100 further includes the housing 3 and a board 4.

The impeller 1 is rotatable about the center axis CA that extends in the top-bottom direction. The impeller 1 is attached to the motor 2. The impeller 1 has an impeller hub 11, centrifugal vanes 13, and axial flow vanes 15. In the present embodiment, the impeller 1 further includes a flange portion 12, a ring portion 14, and a center connection portion 16. The configuration of the impeller 1 will be described later.

The impeller 1 rotates integrally with the motor 2. The motor 2 has the rotor 21 and a stator 22. The motor 2 further includes a shaft 20. The motor 2 rotates the impeller 1. More specifically, the motor 2 rotates the impeller 1 together with the shaft 20 and the rotor 21 by rotating the shaft 20 about the center axis CA.

The shaft 20 is rotatable about the center axis CA and extends in the axial direction. The rotor 21 is fixed to the shaft 20.

The rotor 21 is rotatable about the center axis CA. More specifically, the rotor 21, together with the shaft 20, is rotatable about the center axis CA. The impeller 1 is fixed to the rotor 21. The rotor 21 has a rotor holder 211 and a magnet 212.

The rotor holder 211 has a capped cylinder shape and is attached to the shaft 20. In the present embodiment, the rotor holder 211 is composed of a plate portion 211a and a cylinder portion 211b. The plate portion 211a is fixed to the shaft 20 and extends to the radial-direction outer side from the shaft 20. The cylinder portion 211b extends to the axial-direction lower side from a radial-direction outer end portion of the plate portion 211a. Through holes 211c penetrating the rotor holder 211 in the axial direction are provided on an upper surface of the rotor holder 211. More specifically, the through holes 211c penetrating the plate portion 211a in the axial direction are provided in the plate portion 211a. With this configuration, the airflow sent to the axial-direction lower side by the axial flow vanes 15 of the impeller 1 flows through the through holes 211c and into the motor 2. Therefore, the interior of the motor 2 can be cooled by the airflow sent out by the axial flow vanes 15.

The rotor holder 211 holds the magnet 212. More specifically, the magnet 212 is provided on a radial-direction inner side surface of the cylinder portion 211b of the rotor holder 211. The magnet 212 faces the stator 22 in the radial direction. The magnet 212 has a plurality of magnetic poles that are different from each other and that are disposed in the circumferential direction.

The stator 22 faces at least a portion of the rotor 21 in the radial direction. The rotor 21 rotates by interaction with the magnetic field generated by the stator 22. An upper portion of the stator 22 is disposed on the radial-direction inner side of the cylinder portion 211b of the rotor holder 211 and the magnet 212.

The centrifugal fan 100 includes the housing 3 as described above. The housing 3 houses the impeller 1 therein. In the present embodiment, the housing 3 further houses the motor 2 and the board 4 therein. The housing 3 is provided with an upper suction port 3a and a lower suction port 3b. The upper suction port 3a is provided on an upper surface of the housing 3 and opens in the axial direction on the axial-direction upper side of the impeller 1. The lower suction port 3b is provided on a lower surface of the housing 3 and opens in the axial direction on the axial-direction lower side of the impeller 1. According to these configurations, because the upper suction port 3a and the lower suction port 3b are respectively provided above and below the impeller 1 in the axial direction, it is possible to increase the intake amount of air flowing into the impeller 1. Accordingly, the blowing amount of airflow sent out by the centrifugal fan 100 increases.

Radial-direction inner edge portions of the upper suction port 3a and the lower suction port 3b respectively surround the center axis CA. Here, the “radial-direction inner edge portions” of the upper suction port 3a and the lower suction port 3b are “radial-direction inner edge portions of opening regions” of the upper suction port 3a and the lower suction port 3b, respectively. The opening regions of the upper suction port 3a and the lower suction port 3b are not particularly limited, and in the present embodiment, they are circular about the center axis CA.

In the present embodiment, a radial-direction inner edge of the upper suction port 3a and a radial-direction inner edge of the lower suction port 3b are located on the radial-direction inner side of a radial-direction outer end of the centrifugal vanes 13. Further, note that the present invention is not limited to the example of the present embodiment and that at least one of the radial-direction inner edge of the upper suction port 3a and the radial-direction inner edge of the lower suction port 3b may have the same radial-direction position as the radial-direction outer end of the centrifugal vanes 13. Alternatively, at least one of the radial-direction inner edge of the upper suction port 3a and the radial-direction inner edge of the lower suction port 3b may be located on the radial-direction outer side of the radial-direction outer end of the centrifugal vanes 13.

In addition, the radial-direction inner edge of the upper suction port 3a is located on the radial-direction outer side of a radial-direction inner end of the centrifugal vanes 13. In addition, the radial-direction inner edge of the lower suction port 3b is located on the radial-direction outer side of the radial-direction inner end of the centrifugal vanes 13. According to these configurations, it is possible to increase the intake amount of air flowing into the spaces between the centrifugal vanes 13 from the upper suction port 3a. In addition, it is possible to increase the intake amount of air flowing into the spaces between the centrifugal vanes 13 from the lower suction port 3b. Therefore, the blowing amount of airflow sent out by the centrifugal fan 100 further increases. Further, note that the present invention is not limited to the example of the present embodiment and that at least one of the radial-direction inner edge of the upper suction port 3a and the radial-direction inner edge of the lower suction port 3b may have the same radial-direction position as the radial-direction inner end of the centrifugal vanes 13. Alternatively, at least one of the radial-direction inner edge of the upper suction port 3a and the radial-direction inner edge of the lower suction port 3b may be located on the radial-direction inner side of the radial-direction inner end of the centrifugal vanes 13.

In addition, the housing 3 is provided with an outlet port 3c. The outlet port 3c is provided in a radial-direction outer side surface of the housing 3 and opens at least in the radial direction on the radial-direction outer side of the impeller 1.

In addition, in the present embodiment, the housing 3 is composed of the upper housing 31 and the lower housing 32 that is attached to the axial-direction lower side of the upper housing 31. The upper housing 31 has an upper plate portion 311 and a peripheral wall portion 312. The lower housing 32 has a lower plate portion 321.

The upper plate portion 311 has a plate shape that expands in the radial direction and is located on the axial-direction upper side of the impeller 1. The upper plate portion 311 is provided with the upper suction port 3a. The upper suction port 3a penetrates the upper plate portion 311 in the axial direction.

The peripheral wall portion 312 protrudes to the axial-direction lower side from a radial-direction outer end portion of the upper plate portion 311 and extends along a radial-direction outer end portion of the upper plate portion 311. The peripheral wall portion 312 is provided with the outlet port 3c. The outlet port 3c penetrates the peripheral wall portion 312 in the radial direction.

The lower plate portion 321 is attached to a lower end portion of the peripheral wall portion 312. The lower plate portion 321 has a plate shape that expands in the radial direction and is located on the axial-direction lower side of the impeller 1. The lower plate portion 321 is provided with the lower suction port 3b. The lower suction port 3b penetrates the lower plate portion 321 in the axial direction.

The airflow sucked from the upper suction port 3a and the lower suction port 3b by the centrifugal vanes 13 is sent out to the radial-direction outer side of the impeller 1. The airflow, as viewed from the axial direction, flows along an inner surface of the peripheral wall portion 312 inside the housing 3 and is exhausted to the outside of the centrifugal fan 100 from the outlet port 3c. Further, a portion of the airflow sucked from the upper suction port 3a is sent out to an upper portion of the motor 2 by the axial flow vanes 15 and flows through the through holes 211c of the rotor 21 to a lower portion of the motor 2 and then, together with the airflow sucked from the lower suction port 3b, is sent out to the radial-direction outer side by the centrifugal vanes 13.

In addition, the lower housing 32 is provided with a motor holding portion 321a and ribs 321b. The motor holding portion 321a and the ribs 321b are, as viewed from the axial direction, disposed inside the lower suction port 3b, more specifically, within the opening region of the lower suction port 3b.

The motor holding portion 321a holds the motor 2 and the board 4. More specifically, the motor 2 is held by the motor holding portion 321a with a holding member 2a therebetween. The board 4 faces an upper surface of the lower housing 32 with a gap therebetween and is held by the motor holding portion 321a with the holding member 2a therebetween. In the present embodiment, the motor holding portion 321a is circular about the center axis CA.

The ribs 321b support the motor holding portion 321a. The ribs 321b extend toward the radial-direction inner side from a radial-direction inner edge portion of the opening region of the lower suction port 3b. A radial-direction inner end portion of the ribs 321b is connected to a radial-direction outer end portion of the motor holding portion 321a.

The centrifugal fan 100 has the board 4 as described above. The board 4 is, for example, electrically connected to the stator 22 and is electrically connected to an external circuit of the centrifugal fan 100 via a connection wire (not illustrated) drawn out to the outside of the centrifugal fan 100. The board 4 is disposed on the axial-direction lower side of the motor 2 and is in the shape of a plate extending in the radial direction. In the present embodiment, a radial-direction outer edge of the board 4 is located on the radial-direction inner side of the radial-direction inner end of the centrifugal vanes 13. According to this configuration, the outer edge of the board 4 is disposed on the radial-direction inner side of the radial-direction inner end of the centrifugal vanes 13 so that the board 4 does not interfere with the airflow. Therefore, it is possible to suppress a decrease in the blowing efficiency of the centrifugal vanes 13. Further, note that the present invention is not limited to the example of the present embodiment and the radial-direction outer edge of the board 4 may have the same radial-direction position as the radial-direction inner end of the centrifugal vanes 13. Alternatively, the radial-direction outer edge of the board 4 may be located on the radial-direction outer side of the radial-direction inner end of the centrifugal vanes 13.

Next, the configuration of the impeller 1 will be described. As described above, the impeller 1 has the impeller hub 11, the flange portion 12, the centrifugal vanes 13, the ring portion 14, the axial flow vanes 15, and the center connection portion 16.

The impeller hub 11 houses an upper end portion of the motor 2 therein and is attached to the upper end portion of the motor 2. More specifically, the impeller hub 11 is fixed to the rotor 21. The impeller hub 11 has a cylindrical shape extending in the axial direction. According to this configuration, the air sent out by the axial flow vanes 15 easily flows to the axial-direction lower side. In addition, the rigidity of the impeller 1 is improved.

The impeller 1 has the flange portion 12 as described above. The flange portion 12 extends to the radial-direction outer side from a radial-direction outer side surface of the impeller hub 11. Radial-direction inner end portions of the centrifugal vanes 13 are connected to the flange portion 12. According to this configuration, the strength of the centrifugal vanes 13 can be improved. In addition, with the centrifugal vanes 13, it is possible to send out the airflow sucked from the axial direction to the radial-direction outer side.

A radial-direction outer end of the flange portion 12 is located on the radial-direction inner side of the radial-direction outer end of the centrifugal vanes 13. According to this configuration, because the radial-direction dimension of the flange portion 12 is reduced, the weight of the impeller 1 can be reduced.

In addition, as viewed from the radial direction, the axial-direction position of the flange portion 12 with respect to the centrifugal vanes 13 is not particularly limited, but is preferably the axial-direction center position of the centrifugal vanes 13 as in the present embodiment. That is, the flange portion 12 is preferably connected to the centrifugal vanes 13 at an axial-direction middle position of the radial-direction inner end portions of the centrifugal vanes 13. According to this configuration, at the time of rotation of the impeller 1, the centrifugal vanes 13 are less likely to shake up and down in the axial direction. Therefore, the strength of the centrifugal vanes 13 in the axial direction can be improved. In addition, for example, in the case where air is sucked from both of the upper suction port 3a and the lower suction port 3b provided on both sides of the housing 3 in the axial direction, the flow of the air sucked from either the upper suction port 3a or the lower suction port 3b is also not hindered by the flange portion 12. Therefore, the blowing efficiency is improved as compared with the case where the flange portion 12 is connected to the centrifugal vanes 13 at a position other than the axial-direction middle position of the radial-direction inner end portions of the centrifugal vanes 13.

The centrifugal vanes 13 are disposed in the circumferential direction on the radial-direction outer side of the impeller hub 11. The number of the centrifugal vanes 13 is not limited to a prime number, but is preferably a prime number. If the number of the centrifugal vanes 13 is a prime number, it is possible to suppress noise generated when the centrifugal vanes 13 send out air.

The centrifugal vanes 13 extend in the axial direction from the flange portion 12. In the present embodiment, the radial-direction inner end portions of the centrifugal vanes 13 extend to the axial-direction upper side from an upper surface of the flange portion 12 and extend to the axial-direction lower side from a lower surface of the flange portion 12. According to this configuration, the airflow sucked from the upper suction port 3a and the airflow sucked from the lower suction port 3b can be sent out in the radial direction by the centrifugal vanes 13. However, the present invention is not limited to this example, and the radial-direction inner end portions of the centrifugal vanes 13 may extend to the axial-direction upper side from the upper surface of the flange portion 12 or may extend to the axial-direction lower side from the lower surface of the flange portion 12. In other words, the radial-direction inner end portions of the centrifugal vanes 13 may extend in the axial direction from at least one of the upper surface and lower surface of the flange portion 12.

In the present embodiment, the radial-direction inner end portions of the centrifugal vanes 13 are provided spaced apart from the radial-direction outer side surface of the impeller hub 11 in the radial direction. According to this configuration, it is possible to provide the centrifugal vanes 13 at a position away from the radial-direction outer side surface of the impeller hub in the radial direction. As a result, because the radial-direction length of the centrifugal vanes 13 can be shortened, the impeller 1 can be reduced in weight. Further, note that the present invention is not limited to the example of the present embodiment and the radial-direction inner end portions of the centrifugal vanes 13 may be connected to the radial-direction outer side surface of the impeller hub 11. According to this configuration, the radial-direction inner end portions of the centrifugal vanes 13 extend to the radial-direction outer side from the radial-direction outer side surface of the impeller hub 11. Therefore, the strength of the centrifugal vanes 13 can be improved.

The ring portion 14 has an annular shape about the center axis CA. The ring portion 14 is connected to a radial-direction outer end portion of each of the centrifugal vanes 13 in the circumferential direction. According to this configuration, the strength of the centrifugal vanes 13 can be further improved by the ring portion 14.

As viewed from the radial direction, the axial-direction position of the ring portion 14 with respect to the centrifugal vanes 13 is not particularly limited, but is preferably the axial-direction center position of the centrifugal vanes 13 as in the present embodiment. That is, the ring portion 14 is preferably connected to the centrifugal vanes 13 at the axial-direction middle position of the radial-direction outer end portions of the centrifugal vanes 13. According to this configuration, at the time of rotation of the impeller 1, the centrifugal vanes 13 are less likely to shake up and down in the axial direction. Therefore, the strength of the centrifugal vanes 13 in the axial direction can be improved. In addition, for example, when air is sucked from both of the upper suction port 3a and the lower suction port 3b provided on both sides of the housing 3 in the axial direction, the flow of the air sucked from either the upper suction port 3a or the lower suction port 3b is also not hindered by the ring portion 14. Therefore, as compared with the case where the ring portion 14 is connected to the centrifugal vanes 13 at a position other than the axial-direction middle position of the radial-direction outer end portions of the centrifugal vanes 13, the blowing efficiency is improved.

The axial flow vanes 15 are provided on the radial-direction inner side of the impeller hub 11 and are disposed in the circumferential direction. The number of the axial flow vanes 15 is not limited to a prime number, but is preferably a prime number. If the number of the axial flow vanes 15 is a prime number, noise generated when the axial flow vanes 15 send out air can be suppressed.

The axial flow vanes 15 are disposed on the axial-direction upper side of the stator 22. According to this configuration, a portion of the airflow sucked from the axial direction by the rotation of the impeller 1 having a simple configuration is sent toward the stator 22 inside the motor 2 by the axial flow vanes 15. After cooling the motor 2, for example, a portion of the airflow flows in the radial direction together with the airflow sent out by the centrifugal vanes 13 located on the radial-direction outer side of the impeller hub 11. Therefore, the motor 2 can be cooled with a low-cost configuration.

In the present embodiment, the axial flow vanes 15 extend to the radial-direction inner side from an upper end portion of the impeller hub 11, which has a cylindrical shape, and are connected to the center connection portion 16. According to this configuration, the strength of the impeller 1 can be improved. In addition, because at least a portion of the rotor 21 can be disposed inside the impeller hub 11, the axial-direction dimension of the centrifugal fan 100 can be reduced.

Radial-direction outer end portions of the axial flow vanes 15 are connected to the upper end portion of the impeller hub 11. Radial-direction inner end portions of the axial flow vanes 15 are connected to the center connection portion 16 disposed at the center of the impeller hub 11. According to this configuration, the strength of the axial flow vanes 15 can be improved. In addition, the strength of the impeller 1 can be improved.

In addition, in the present embodiment, a radial-direction outer end of the axial flow vanes 15 is disposed on the radial-direction inner side of the radial-direction inner edge of the upper suction port 3a. According to this configuration, the intake amount of air flowing from the upper suction port 3a can be increased. In addition, it is easy to guide a portion of the air sucked from the upper suction port 3a to the radial-direction outer side of the radial-direction outer end of the axial flow vanes 15. Therefore, the blowing amount of airflow sent out by the centrifugal fan 100 further increases. However, the present invention is not limited to the example of the present embodiment, and the radial-direction outer end of the axial flow vanes 15 may be disposed at the same radial-direction position as the radial-direction inner edge of the upper suction port 3a. Alternatively, the radial-direction outer end of the axial flow vanes 15 may be disposed on the radial-direction outer side of the radial-direction inner edge of the upper suction port 3a.

In the present embodiment, the axial-direction position of an axial-direction upper end of the axial flow vanes 15 is the same as the axial-direction position of an axial-direction upper end of the center connection portion 16. However, the present invention is not limited to this example, and the axial-direction position of the axial-direction upper end of the axial flow vanes 15 may be on the axial-direction lower side of the axial-direction position of the axial-direction upper end of the center connection portion 16.

Alternatively, the axial-direction position of an axial-direction upper end of the axial flow vanes 15 may be on the axial-direction upper side of the axial-direction position of the axial-direction upper end of the center connection portion 16. In other words, at least a portion of the axial flow vanes 15 may face the radial-direction inner edge of the upper suction port 3a in the radial direction. According to this configuration, because the axial flow vanes 15 can be disposed on the axial-direction upper side as much as possible, more air can be sent from the upper suction port 3a to the axial flow vanes 15.

In addition, in the present embodiment, the axial-direction position of the axial-direction lower end of the axial flow vanes 15 is on the axial-direction upper side of the axial-direction position of the axial-direction lower end of the center connection portion 16. However, the present invention is not limited to this example, and the axial-direction position of the axial-direction lower end of the axial flow vanes 15 may be the same as the axial-direction position of the axial-direction lower end of the center connection portion 16. With this configuration, it is possible to make the centrifugal fan 100 thinner and increase the axial-direction width of the axial flow vanes 15. Therefore, for example, the rotational-direction front side of the axial flow vanes 15 can be inclined to the axial-direction lower side going toward the rotational-direction front side of the axial flow vanes 15. Therefore, the blowing amount of the centrifugal fan 100 can be improved.

In addition, in the present embodiment, the axial flow vanes 15 are disposed on the axial-direction upper side of an axial-direction upper end of the centrifugal vanes 13. With this configuration, on the upstream side of the airflow drawn by the centrifugal vanes 13, air can also be sent to the axial flow vanes 15. Therefore, the amount of air that can be sent out by the axial flow vanes 15 can be increased. However, the present invention is not limited to the example of the present embodiment, and the axial flow vanes 15 may be disposed at the same axial-direction position as the centrifugal vanes 13 or may be disposed on the axial-direction lower side of the centrifugal vanes 13.

The center connection portion 16 is disposed on the radial-direction inner side of the impeller hub 11 and is fixed to an upper end portion of the shaft 20. In the present embodiment, the center connection portion 16 has a plate shape extending in the radial direction from the center axis CA, but it is not limited to this example. The center connection portion 16 may have an annular shape about the center axis CA through which the shaft 20 is inserted.

Next, a modification example of the present embodiment will be described. Hereinafter, a configuration different from the above embodiment will be described. In addition, the same reference numerals are given to the same constituent elements as those in the above-described embodiment and description thereof may be omitted.

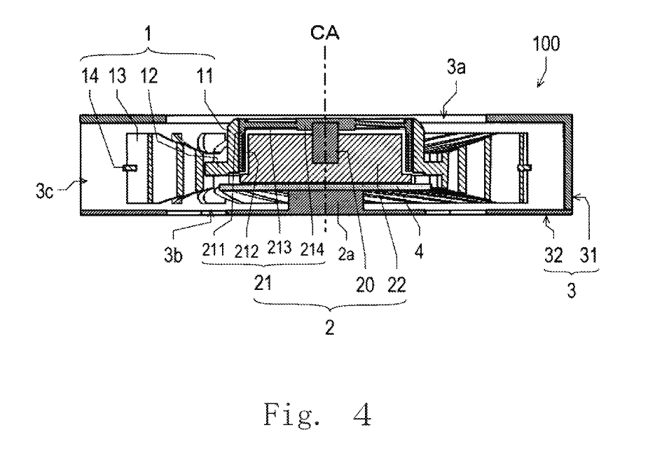

FIG. 4 is a sectional view illustrating the centrifugal fan 100 of another configuration example as viewed from the radial direction. Further, FIG. 4 is a cross section of the centrifugal fan 100 taken along a plane including the center axis CA along a one-dot chain line A-A in FIG. 1.

In the centrifugal fan 100 according to the modification example, the impeller 1 includes the impeller hub 11 and the centrifugal vanes 13. In addition, in this modification example, the impeller 1 further includes the flange portion 12 and the ring portion 14. That is, the impeller 1 according to the modification example does not have the axial flow vanes 15 and the center connection portion 16 of the above-described embodiment. On the other hand, the rotor 21 further includes axial flow vanes 213 in addition to the rotor holder 211 and the magnet 212. The magnet 212 faces the stator 22 in the radial direction. The rotor holder 211 holds the magnet 212. The axial flow vanes 213 are disposed in the circumferential direction on the radial-direction inner side of the impeller hub 11. Furthermore, the rotor 21 further has a center connection portion 214. The impeller hub 11 is fixed to the rotor 21. The centrifugal vanes 13 are disposed in the circumferential direction on the radial-direction outer side of the impeller hub 11.

In the modification example, the axial flow vanes 213 are disposed in the circumferential direction on the radial-direction inner side of the impeller hub 11 and the rotor holder 211 of the rotor 21. The axial flow vanes 213 are provided in the rotor holder 211 and are located on the axial-direction upper side of the stator 22. According to this configuration, a portion of the airflow sucked from the axial direction by the rotation of the rotor 21 and the impeller 1 is sent toward the inside of the motor 2 by the axial flow vanes 213. After cooling the motor 2, for example, a portion of the airflow flows in the radial direction together with the airflow sent out by the centrifugal vanes 13 located on the radial-direction outer side of the impeller hub 11. Therefore, the motor 2 can be cooled with a low-cost configuration. In addition, for example, when the rotor holder 211 is formed of metal, the rigidity of the axial flow vanes 213 can be improved.

In addition, the axial flow vanes 213 extend to the radial-direction inner side from an upper end portion of the rotor holder 211 of the rotor 21 and are connected to the center connection portion 214. According to this configuration, the strength of the impeller 1 can be improved. In addition, the rotor 21 can be disposed on the radial-direction inner side of the impeller hub 11. In other words, the rotor 21 can be disposed inside the impeller hub 11. Therefore, the axial-direction dimension of the centrifugal fan 100 can be reduced.

Radial-direction outer end portions of the axial flow vanes 213 are connected to the upper end portion of the rotor holder 211. Radial-direction inner end portions of the axial flow vanes 213 are connected to a radial-direction outer end portion of the center connection portion 214 disposed at the center of the rotor holder 211. According to this configuration, the strength of the axial flow vanes 213 can be improved.

In addition, in the present embodiment, a radial-direction outer end of the axial flow vanes 213 is disposed on the radial-direction inner side of the radial-direction inner edge of the upper suction port 3a. According to this configuration, it is possible to increase the intake amount of air flowing into the spaces between the axial flow vanes 213 and the spaces between the centrifugal vanes 13 at the upper suction port 3a. Therefore, the blowing amount of airflow sent out by the centrifugal fan 100 further increases. However, the present invention is not limited to the example of the present embodiment, and the radial-direction outer end of the axial flow vanes 213 may be disposed at the same radial-direction position as the radial-direction inner edge of the upper suction port 3a. Alternatively, the radial-direction outer end of the axial flow vanes 213 may be disposed on the radial-direction outer side of the radial-direction inner edge of the upper suction port 3a.

In the present embodiment, the axial-direction position of an axial-direction upper end of the axial flow vanes 213 is the same as the axial-direction position of an axial-direction upper end of the center connection portion 214. However, the present invention is not limited to this example, and the axial-direction position of the axial-direction upper end of the axial flow vanes 213 may be on the axial-direction lower side of the axial-direction position of the axial-direction upper end of the center connection portion 214. Alternatively, the axial-direction position of the axial-direction upper end of the axial flow vanes 213 may be on the axial-direction upper side of the axial-direction position of the axial-direction upper end of the center connection portion 214. In other words, at least a portion of the axial flow vanes 213 may be disposed inside the upper suction port 3a. According to this configuration, on the upstream side of the airflow drawn by the centrifugal vanes 13, more air can be sent to the axial flow vanes 213.

In addition, in the present embodiment, the axial-direction position of an axial-direction lower end of the axial flow vanes 213 is on the axial-direction upper side of the axial-direction position of an axial-direction lower end of the center connection portion 214. However, the present invention is not limited to this example, and the axial-direction position of the axial-direction lower end of the axial flow vanes 213 may be the same as the axial-direction position of the axial-direction lower end of the center connection portion 214. According to this configuration, it is possible to make the centrifugal fan 100 thinner and increase the axial-direction width of the axial flow vanes 213. Therefore, the blowing amount of the centrifugal fan 100 can be improved.

In addition, in the present embodiment, the axial flow vanes 213 are disposed on the axial-direction upper side of the axial-direction upper end of the centrifugal vanes 13. According to this configuration, on the upstream side of the airflow drawn by the centrifugal vanes 13, air can also be sent to the axial flow vanes 213. However, the present invention is not limited to the example of the present embodiment, and the axial flow vanes 213 may be disposed at the same axial-direction position as the centrifugal vanes 13 or may be disposed on the axial-direction lower side of the centrifugal vanes 13.

The center connection portion 214 is disposed on the radial-direction inner side of the rotor holder 211 of the rotor 21 and is fixed to the upper end portion of the shaft 20. In the present embodiment, the center connection portion 214 has a plate shape extending in the radial direction from the center axis CA, but is not limited to this example. The center connection portion 214 may have an annular shape about the center axis CA through which the shaft 20 is inserted.

For example, in the above-described embodiment and the modification example thereof, air is exemplified as the fluid to be sucked and sent out by the centrifugal fan 100; however, the present disclosure is not limited to this example. For example, the fluid to be sucked and sent out by the centrifugal fan 100 may be a gas other than air or may be a liquid such as water.

The present disclosure is useful as, for example, a thin blowing fan. However, in the application of the present disclosure, it is not limited to this example.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A centrifugal fan that sends out in a radial direction a fluid sucked from an axial direction, the centrifugal fan comprising:
an impeller rotatable about a center axis extending in a top-bottom direction; and
a motor that rotates the impeller; wherein
the motor includes:
a rotor rotatable about the center axis; and
a stator that faces at least a portion of the rotor in the radial direction;
the impeller includes:
an impeller hub fixed to the rotor;
a plurality of centrifugal vanes disposed in a circumferential direction on a radial-direction outer side of the impeller hub; and
a plurality of axial flow vanes disposed in the circumferential direction on a radial-direction inner side of the impeller hub; wherein
the axial flow vanes are disposed on an axial-direction upper side of the stator.

2. The centrifugal fan according to claim 1, wherein the axial flow vanes extend to the radial-direction inner side from an upper end portion of the impeller hub.

3. The centrifugal fan according to claim 1, wherein the rotor includes:
a magnet that faces the stator in the radial direction;
a rotor holder that holds the magnet; and
a through hole that penetrates the rotor holder in the axial direction and is provided on an upper surface of the rotor holder.

4. The centrifugal fan according to claim 1, wherein the impeller hub has a cylindrical or substantially cylindrical shape extending in the axial direction.

5. The centrifugal fan according to claim 1, wherein the axial flow vanes are disposed on the axial-direction upper side of an axial-direction upper end of the centrifugal vanes.

6. The centrifugal fan according to claim 1, wherein radial-direction inner end portions of the axial flow vanes are respectively connected to a center connection portion disposed at a center of the impeller hub.

7. The centrifugal fan according to claim 6, wherein
an axial-direction position of an axial-direction upper end of the axial flow vanes is identical to an axial-direction position of an axial-direction upper end of the center connection portion; and
an axial-direction position of an axial-direction lower end of the axial flow vanes is identical to an axial-direction position of an axial-direction lower end of the center connection portion.

8. The centrifugal fan according to claim 1, wherein radial-direction inner end portions of the centrifugal vanes are spaced apart from a radial-direction outer side surface of the impeller hub in the radial direction.

9. The centrifugal fan according to claim 1, wherein radial-direction inner end portions of the centrifugal vanes are connected to a radial-direction outer side surface of the impeller hub.

10. The centrifugal fan according to claim 1, wherein
the impeller further includes a flange portion extending to the radial direction outer side from a radial-direction outer side surface of the impeller hub; and
radial-direction inner end portions of the centrifugal vanes are connected to the flange portion.

11. The centrifugal fan according to claim 10, wherein a radial-direction outer end of the flange portion is located on the radial-direction inner side of a radial-direction outer end of the centrifugal vanes.

12. The centrifugal fan according to claim 10, wherein the flange portion is connected to the centrifugal vanes at an axial-direction middle position of the radial-direction inner end portions of the centrifugal vanes.

13. The centrifugal fan according to claim 1, wherein the impeller further includes a ring portion that connects radial-direction outer end portions of the centrifugal vanes in the circumferential direction.

14. The centrifugal fan according to claim 13, wherein the ring portion is connected to the centrifugal vanes at an axial-direction middle position of the radial-direction outer end portions of the centrifugal vanes.

15. The centrifugal fan according to claim 13, further comprising:
a board that is disposed on an axial-direction lower side of the motor and is in a shape of a plate extending in the radial direction; wherein
a radial-direction outer edge of the board is located on the radial-direction inner side of a radial-direction inner end of the centrifugal vanes.

16. The centrifugal fan according to claim 1, further comprising:
a housing that houses the impeller; wherein
an upper suction port that opens in the axial direction is provided on an upper surface of the housing on the axial-direction upper side of the impeller; and
a lower suction port that opens in the axial direction is provided on a lower surface of the housing on an axial-direction lower side of the impeller.

17. The centrifugal fan according to claim 16, wherein a radial-direction inner edge of the upper suction port is located on the radial-direction outer side of a radial-direction inner end of the centrifugal vanes.

18. The centrifugal fan according to claim 16, wherein a radial-direction outer end of the axial flow vanes is disposed on the radial-direction inner side of a radial-direction inner edge of the upper suction port.

19. The centrifugal fan according to claim 16, wherein at least a portion of the axial flow vanes faces a radial-direction inner edge of the upper suction port in the radial direction.
